(19) United States
(12) Patent Application Publication
(10) Pub. No.: US 2024/0404543 A1
(43) Pub. Date: Dec. 5, 2024

(54) JOINT FAR-END AND NEAR-END SPEECH INTELLIGIBILITY ENHANCEMENT

(71) Applicant: RTX A/S, Nørresundby (DK)

(72) Inventor: Andreas Jonas FUGLSIG, Nørresundby (DK)

(21) Appl. No.: 18/698,158

(22) PCT Filed: Oct. 4, 2022
(86) PCT No.: PCT/EP2022/077504

§ 371 Date: Apr. 3, 2024

(30) Foreign Application Priority Data
Oct. 5, 2021 (DK) PA 2021 70488

(51) Int. Cl. G10L 21/0232; G10L 21/0216; G10L 21/034; G10L 21/0364; H04M 9/08

(52) U.S. Cl. CPC G10L 21/0232; G10L 21/034; G10L 21/0364; H04M 9/087; G10L 2021/02166

(57) ABSTRACT

The invention relates to a computer implemented method for generation of a speech intelligibility enhancement algorithm for a wireless two-way communication system to enhance speech intelligibility in noise at both a near-end and a far-end taking into account joint near-end and far-end noise and audio inputs at the far-end from multiple microphones to capture speech and noise. First, determining (D_SI_OT) a speech intelligibility optimization target, taking into account noise at the near-end and noise at the far-end. Next, determining (D_MVDR) a Minimum Variance Distortionless Response (MVDR) beamformer with a plurality of inputs by optimizing a cost function according to the speech intelligibility optimization target to determine a global optimum. Next, determining (D_FB_G) a set of frequency band dependent gains by optimizing a cost function according to the speech intelligibility optimization target to determine a global optimum of a concave optimization formulation. Finally, generating (G_SIE_A) the speech enhancement processing algorithm as a linear processor with the determined MVDR beamformer followed by the determined set of frequency band dependent gains. In this way, a simple technical-mathematical formulation has been achieved, and the resulting speech intelligibility enhancement is similar to related but complex prior art solutions. The resulting algorithm is suited for wireless two-way communication devices, such as intercom devices to be used in noisy environments. e.g. for firefighters, rescue personnel etc.

### FIELD OF THE INVENTION

The present invention relates to the field of wireless audio, such as wireless speech transmission, such as wireless two-way speech communication. More specifically the invention provides a joint far-end and near-end speech intelligibility enhancement for enhancing speech intelligibility in the case of noise both at the far-end and at the near-end.

### BACKGROUND OF THE INVENTION

Wireless two-way speech communication in noisy environments is a known problem. Especially, speech intelligibility can be severely decreased if both the speaking person at the near-end and the speaking person at the far-end of the two-way communication are located in environments where the acoustic noise level is high. The problem is known from mobile phone communication when one or both persons involved in the communication are located outside in traffic noise or the like. Specifically, speech intelligibility is important for communication between persons involved in a critical or even life-threatening situation, such as communication between rescue personnel, fire fighters etc.

Introduction of a speech enhancement processing in the communication link is a known measure to improve speech intelligibility in the presence of noise both at the far-end and at the near-end. To allow an effective speech enhancement, one approach is to use multi-microphone techniques at both far-end and near-end. Further, it has been proposed to use mutual information between spoken message at far-end environment and perceived message at the near-end as speech intelligibility enhancement target.

One example of such speech enhancement algorithm using mutual information can be found in “Intelligibility Enhancement Based on Mutual Information”, S. Khademi et al., IEEE/ACM Transactions on Audio, Speech, and Language Processing, Vol. 25, No. 8, August 2017. However, in this example, the mathematical optimization problem is complex since e.g. the natural variation of speech is taken into account. This introduces complexity in the optimization process to arrive at the speech intelligibility enhancement algorithm, and to perform the optimization, various assumptions are required to arrive at a closed form mathematical formulation. Furthermore, the required assumptions may not even be fulfilled in practice. Thus, the resulting speech enhancement algorithm is complex to derive and it may further be inaccurate due to invalid assumptions, thereby leading to a non-optimal speech enhancement performance.

### SUMMARY OF THE INVENTION

Thus, according to the above description, it is an object of the present invention to provide a speech enhancement algorithm with a high speech enhancement performance and at the same time it is preferred that the optimization process of deriving the speech enhancement algorithm only a limited complexity is required.

In a first aspect, the invention provides a computer implemented method for providing a speech enhancement processing algorithm for enhancement of speech intelligibility in a wireless audio system for wireless transmission of audio between a far-end and a near-end, with multiple microphones at least at the far-end and at least one audio output at the near-end, the method comprises
1) determining a speech intelligibility optimization target, taking into account noise at the near-end and noise at the far-end,
2) determining, according to a predetermined algorithm, a Minimum Variance Distortionless Response (MVDR) beamformer with a plurality of inputs by optimizing a cost function according to the speech intelligibility optimization target to determine a global optimum,
3) determining, according to a predetermined algorithm, a set of frequency band dependent gains by optimizing a cost function according to the speech intelligibility optimization target to determine a global optimum of a concave optimization formulation, and
4) generating the speech enhancement processing algorithm comprising the determined MVDR beamformer followed by the determined set of frequency band dependent gains.

Such method provides an efficient speech enhancement processing algorithm in an efficient way taking into account joint near-end and far-end based on a speech intelligibility optimization target, e.g. involving an Approximated Speech Intelligibility Index (ASII) or other optimization target, such as a target based on an Extended Short-Time Objective Intelligibility (ESTOI).

The invention is based on a combined technical and mathematical insight, that such optimization target can be formulated without the need to make a number of various assumptions, which may not be realistic in practice (e.g. the so-called production noise and interpretation noise as well as critical band powers to be zero-mean independent Gaussian random variables). The elimination of assumptions leads to a simpler closed-form formulation and thus a less complex computer problem to be optimized, namely especially a concave optimization formulation to determine the set of frequency band dependent gains.

The method has been tested with respect to speech intelligibility performance of the resulting speech intelligibility enhancement algorithm for speech in far-end and near-end noisy environments. It has been found to provide speech intelligibility performance which is similar to the more complex methods for generating a speech intelligibility enhancement algorithm of the prior art, specifically the paper Background section. Thus, a simpler method has been provided to achieve the same goal, even without the need to require various assumptions to be fulfilled as in the prior art. Therefore, the method provided forms the basis for further developments towards algorithms which can provide even higher speech intelligibility enhancements.

In the following preferred embodiments and features will be described.

The term ‘MVDR beamformer’ is known in the field of signal processing, such as for hearing aids. Especially, an example may be seen in “Intelligibility Enhancement Based on Mutual Information”, S. Khadeemi et al., IEEE/ACM Transactions on Audio, Speech, and Language Processing, Vol. 25, No. 8, August 2017.

The method preferably comprises the step of storing the generated speech enhancement processing algorithm, or at least parameters indicative of the algorithm, in a memory of a processor system of a wireless two-way communication system, so as to enable the algorithm to function with realtime audio inputs. E.g. the method is performed by another device in an offline process, and then downloaded to a memory of a wireless two-way communication device, or the communication device itself may be capable of performing the method. Especially, the steps 1)-4) are performed only once, such as offline.

Especially, the speech enhancement processing algorithm may be arranged to process at least two microphone inputs from the far-end. Especially, the speech enhancement processing algorithm may be arranged to process such as 2-10 microphone inputs from the far-end. Preferably, the speech enhancement algorithm is arranged to generate an audio output in response to the plurality of microphone inputs and at least one input indicative of noise at the near-end.

The speech intelligibility optimization target preferably takes into account only: noise at the far-end and noise at the near-end. However, in other embodiments further parameter(s) may be taken into account in the target. Especially, the speech intelligibility optimization target involves an approximated speech intelligibility index measure (ASII) and/or a target based on an Extended Short-Time Objective Intelligibility (ESTOI) measure. The speech intelligibility optimization target may involve an equal power constraint.

The set of frequency band dependent gains preferably comprises a set of critical band dependent gains. Especially, it may be a constraint that all frequency dependent gains within a critical band are equal.

The term ‘critical band’ is well known within the field of psychoacoustics, and is related to the frequency band characteristics of the human hearing.

The determining of the MVDR beamformer may involve optimizing a cost function with a Lagrangian formulation.

Preferably, at least one room acoustic parameter indicative of acoustics environments at the far-end is taken into account in the determining of at least one of: the MVDR beamformer, and the set of frequency band dependent gains.

The method may further comprise storing the speech intelligibility enhancement processing algorithm in a memory of a processor system on a wireless two-way communication device comprising a plurality of audio inputs and at least one audio output.

The method may be performed online, i.e. to allow updating of parameters of the speech enhancement processing algorithm, e.g. to adapt to various environments etc. for optimal speech intelligibility under various conditions.

In general, the method is understood to be programmable on a computer system, and compared to prior art methods, the computations to be performed are less complex.

In a second aspect, the invention provides a computer program code arranged to cause, when executed on a device with a processor, to perform the method according to the first aspect. Especially, the program code may be suited for execution on a general computer, e.g. a PC, or tablet or the like, or it may be arranged to be performed on a dedicated signal processor or the like, e.g. a signal processor in a mobile device, e.g. in a wireless two-way communication device. However, the program code may be designed to be executed on one device and capable of providing the speech intelligibility enhancement algorithm output in a format to be stored into or downloaded into a wireless two-way communication device.

In a third aspect, the invention provides a wireless audio device comprising a processor system programmed to process a plurality of audio inputs, such as generated by respective microphones, according to the speech enhancement processing algorithm generated according to the method according to the first aspect. Especially, the audio device may be arranged to generate an audio output in accordance with the speech enhancement processing algorithm and to transmit said audio output represented in a wireless signal to a second wireless device.

Especially, the wireless audio device may be arranged to receive an input indicative of noise from the second wireless device, and wherein the wireless audio device is arranged to apply said input indicative of noise from the second wireless device as input to the speech enhancement processing algorithm. Specifically, the audio device may be arranged for wireless two-way audio communication with the second wireless device. Especially, the audio device may be arranged to receive a wireless signal with an audio input represented therein, and being arranged to generate an acoustic output according to said received audio input, e.g. by applying the audio input to a loudspeaker. Especially, the wireless audio device may comprise a plurality of microphones, such as 2-10 microphones or more, connected to generate said respective audio inputs to the speech intelligibility enhancement algorithm. Especially, the wireless audio device may comprise a wireless RF transmitter arranged to operate according to an RF transmission protocol selected from the group of: Digital Enhanced Cordless Telecommunication, Bluetooth, Bluetooth Low Energy or Bluetooth Smart, Cellular 4G or 5G, and a proprietary RF protocol. Especially, the wireless audio device may be one of: a headset, an intercom device, a handset, and a table-top communication device.

Specifically, the wireless audio device may be a two-way intercom device built into a helmet arranged to be worn by a person. More specifically, the two-way intercom device being partly or fully built into a firefighter helmet.

The speech intelligibility enhancement algorithm may be fully implemented on a far-end device which thus transmits a pre-processed speech enhanced audio signal in wireless format to the near-end device which received one or more parameters or values represented in a wireless signal received from the near-end device, e.g. a noise signal may be received from the near-end device. In some embodiments, a first part of the speech intelligibility enhancement algorithm may be implemented on the far-end device, while a second part of the speech intelligibility enhancement algorithm is implemented on the near-end device.

In a Public Address system, the far-end device may only be arranged to transmit enhanced audio and not necessarily be arranged for two-way communication.

However, in other systems the wireless audio device is a wireless two-way speech communication device.

In a fourth aspect, the invention provides a wireless audio system comprising at a first wireless audio device according to the second aspect to operate as a far-end device, and at least a second wireless audio device arranged to receive an audio output from the first wireless audio device and to generate an audio output, such as an acoustic output, accordingly. Especially, both of the first and second wireless audio devices are arranged for two-way speech communication. Especially, the wireless audio system may comprise a plurality of wireless audio devices according to the second aspect. The system may be a two-way speech communication system.

In a fifth aspect, the invention provides use of the wireless audio device according to the third aspect or use of the wireless audio system according to the fourth aspect for two-way speech communication.

In a sixth aspect, the invention provides a system comprising a processor programmed to perform the method according to the first aspect, and to generate an output indicative of the generated speech intelligibility enhancement algorithm accordingly.

It is appreciated that the same advantages and embodiments described for the first aspect apply as well the further mentioned aspects. Further, it is appreciated that the described embodiments can be intermixed in any way between all the mentioned aspects.

### BRIEF DESCRIPTION OF THE FIGURES

The invention will now be described in more detail with regard to the accompanying figures of which

FIG. 1 illustrates the addressed two-way communication scenario with noise at the far-end and as well as the near-end,

FIG. 2 shows steps of a method embodiment,

FIG. 3 illustrates an overall system model,

FIG. 4 illustrates a preferred signal model, and

FIG. 5 illustrates a two-way communication device embodiment.

The figures illustrate specific ways of implementing the present invention and are not to be construed as being limiting to other possible embodiments falling within the scope of the attached claim set.

### DETAILED DESCRIPTION OF THE INVENTION

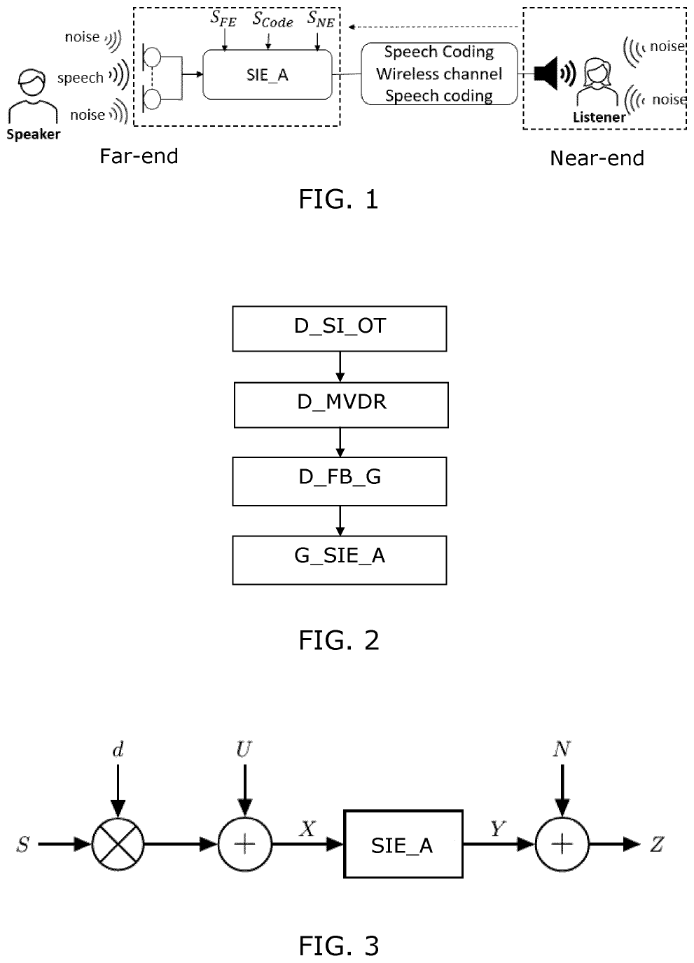

FIG. 1 shows the overall scenario of a wireless two-way communication with wirelessly connected device each with a plurality of microphones and at least one acoustic output, e.g. a loudspeaker or headphone. In the illustration, a speaker speaks in a noisy environment at the far-end, and the listener at the near-end listens to audio generated in response to a plurality of microphones at the far-end. The speech intelligibility enhancement algorithm SIE_A is inserted as a linear processor to enhance speech intelligibility at the near-end.

FIG. 2 shows steps of an embodiment of the method, namely a method for providing a speech enhancement processing algorithm by means of a computer or other suitable processor. The speech enhancement processing algorithm serves to enhance speech intelligibility in a wireless two-way communication system between a far-end and a near-end, with multiple microphones at least at the far-end and where at least one audio output is generated at the near-end based on an output of the far-end microphone inputs processed by the speech enhancement processing algorithm. The method comprises determining D_SI_OT a speech intelligibility optimization target, taking into account noise at the near-end and noise at the far-end. Further, determining D_MVDR, according to a predetermined algorithm, a Minimum Variance Distortionless Response (MVDR) beamformer with a plurality of inputs by optimizing a cost function according to the speech intelligibility optimization target to determine a global optimum. Further, determining D_FB_G, according to a predetermined algorithm, a set of frequency band dependent gains by optimizing a cost function according to the speech intelligibility optimization target to determine a global optimum of a concave optimization formulation and generating G_SIE_A the speech enhancement processing algorithm comprising the determined MVDR beamformer followed by the determined set of frequency band dependent gains. The method may be performed offline by another device than the wireless two-way communication device for which it is intended, or the wireless two-way communication device may comprise a processor capable of performing the method to allow updating of parameters of the speech enhancement processing algorithm.

FIG. 3 shows a system model involving the speech intelligibility enhancement algorithm SIE_A in the signal path taking X as input, where X is the audio inputs generated by the microphones capturing speech and noise at the far-end. Preferably, X is represented in the STFT domain. The audio output from the algorithm SIE_A is denoted Y. S is the clean speech, U is noise at the far-end, and N is noise at the hear end. The room acoustics at the far-end is taken into account by d, namely time-frequency coefficients of the room transfer function from target speaker to microphone. Z is the resulting output at the near-end which is the output from the algorithm SIE_A contaminated by noise N at the near-end. Thus, the below relations apply:

$${X}_{k , i} = {d}_{k , i} {S}_{k , i} + {U}_{k , i} , {Y}_{k , i} = υ {X}_{k , i} ,$$

$${Z}_{k , i} = {Y}_{k , i} + {N}_{k , i}$$

Preferably, S, U and N are assumed to be stationary sequences of complex random vectors of STFT coefficients. However, no assumptions on the particular marginal distribution of the signals is required. There is assumed independence, i.e. only assumptions on the joint distribution of the signals are made.

Compared to prior art solutions, the frequency dependent gains aⱼ can be optimized according to the below formulation which is concave.

$${sup}_{\{ {α}_{j} \} ∈} {\sum }_{j} γ j \frac{{α}_{j} {σ}_{{𝒮}_{j}}^{2}}{{α}_{j} {σ}_{{𝒮}_{j}}^{2} + {α}_{j} {σ}_{{ℬ}_{j}}^{2} + {σ}_{{𝒩}_{j}}^{2}}$$

$$subject to {𝒞}_{1} : {\sum }_{j} {α}_{j} {σ}_{{𝒮}_{j}}^{2} = {\sum }_{j} {σ}_{{𝒮}_{j}}^{2}$$

The following expression can then be obtained:

$${α}_{j} = max \{ \frac{\sqrt{{σ}_{{𝒩}_{j}}^{2}} \sqrt{{γ}_{j}}}{\sqrt{ν} ( {σ}_{{𝒮}_{j}}^{2} + {σ}_{{ℬ}_{j}}^{2} )} - \frac{{σ}_{{𝒩}_{j}}^{2}}{{σ}_{{𝒮}_{j}}^{2} + {σ}_{{ℬ}_{j}}^{2}} , 0 \} , ∀ j$$

Here v is given by:

$$\frac{1}{\sqrt{ν}} = ( r + {\sum }_{j ∈ 𝒥} \frac{{σ}_{{𝒮}_{j}}^{2} ( {σ}_{{𝒩}_{j}}^{2} )}{{σ}_{{𝒮}_{j}}^{2} + {σ}_{{B}_{J}}^{2}} ) / ( {\sum }_{j ∈ 𝒥} ( \frac{{σ}_{{𝒮}_{j}}^{2} \sqrt{{σ}_{{N}_{j}}^{2}} \sqrt{γ j}}{( {σ}_{{𝒮}_{j}}^{2} + {σ}_{{B}_{j}}^{2} )} ) ) .$$

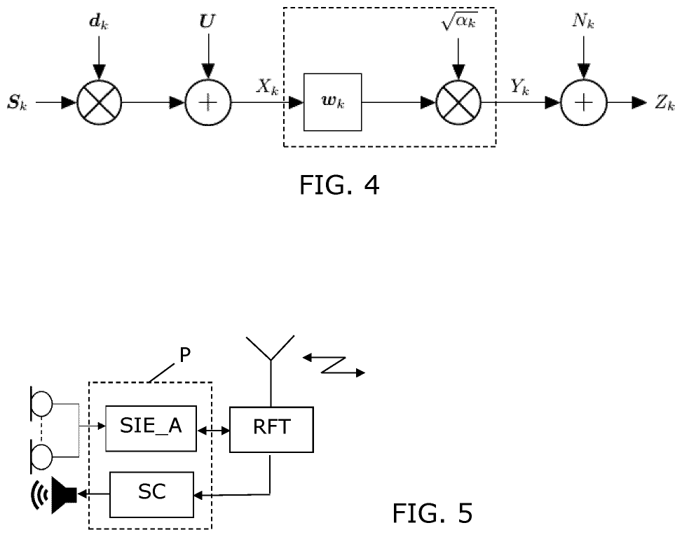

FIG. 4 shows the overall signal model where X is the input to the MVDR beamformer w, followed by the frequency band dependent gains a. Speech intelligibility enhancement algorithm is thus indicated with dashed line taking X as input and outputs Y.

A specific example of a procedure for optimization of critical band dependent gains a is seen below.

| | |
|---|---|
| 1: | procedure ASII OPTIMIZATION(σ_{S}_{ⱼ}², σ_{B}_{ⱼ}², σ_{N}_{ⱼ}²) |
| 2: | n ← 0 |
| 3: | Mⱼ[n] ← 0, ∀j |
| 4: | r ← Σⱼσ_{S}_{ⱼ}² |
| 5: | n ← n + 1 |
| 6: | $ν [ n ] ← {( \frac{{\sum }_{j} ( \frac{{σ}_{{𝒮}_{j}}^{2} \sqrt{{σ}_{{𝒩}_{j}}^{2}} \sqrt{{γ}_{j}}}{( {σ}_{{𝒮}_{j}}^{2} + {σ}_{{𝔅}_{j}}^{2} )} )}{r + {\sum }_{j} \frac{{σ}_{{𝒮}_{j}}^{2} {σ}_{{𝒩}_{j}}^{2}}{{σ}_{{𝒮}_{j}}^{2} + {σ}_{{𝔅}_{j}}^{2}}} )}^{2}$ |
| 7: | ${α}_{j} [ n ] ← \frac{\sqrt{{σ}_{{𝒩}_{j}}^{2}} \sqrt{{γ}_{j}}}{\sqrt{v [ n ]} ( {σ}_{{𝒮}_{j}}^{2} + {σ}_{{𝔅}_{j}}^{2} )} - \frac{{σ}_{{𝒩}_{j}}^{2}}{{σ}_{{𝒮}_{j}}^{2} + {σ}_{{𝔅}_{j}}^{2}} , \qquad ∀ j$ |

Here line 2 is counter initialization, line 3 is mask initialization, line 6 is the initial sum across all critical bands.

The specific procedure continues with the following steps.

| | |
|---|---|
| 8: | for j ← 1 to J do |
| 9: | if αⱼ[n] > 0 then |
| 10: | Mⱼ[n] ← 1 |
| 11: | else |
| 12: | Mⱼ[n] ← 0 |
| 13: | while Mⱼ[n] ≠ Mⱼ[n − 1]∀j do |
| 14: | n ← n + 1 |
| 15: | $ν [ n ] ← {( \frac{{\sum }_{j ∈ 𝒥} ( \frac{{σ}_{{𝒮}_{j}}^{2} \sqrt{{σ}_{{𝒩}_{j}}^{2}} \sqrt{{γ}_{j}}}{( {σ}_{{𝒮}_{j}}^{2} + {σ}_{{𝔅}_{j}}^{2} )} )}{r + {\sum }_{j ∈ 𝒥} \frac{{σ}_{{𝒮}_{j}}^{2} {σ}_{{𝒩}_{j}}^{2}}{{σ}_{{𝒮}_{j}}^{2} + {σ}_{{𝔅}_{j}}^{2}}} )}^{2}$ |
| 16: | ${α}_{j} [ n ] ← \frac{\sqrt{{σ}_{{𝒩}_{j}}^{2}} \sqrt{{γ}_{j}}}{\sqrt{v [ n ]} ( {σ}_{{𝒮}_{j}}^{2} + {σ}_{{𝔅}_{j}}^{2} )} - \frac{{σ}_{{𝒩}_{j}}^{2}}{{σ}_{{𝒮}_{j}}^{2} + {σ}_{{𝔅}_{j}}^{2}} , \qquad ∀ j$ |

Here line 13 indicates “continue until all aⱼ does no longer change sign”, and line 15 indicates “only sum across j where Mⱼ=1”. The final steps of the procedure are indicated below.

| | |
|---|---|
| 16: | ${α}_{j} [ n ] ← \frac{\sqrt{{σ}_{{𝒩}_{j}}^{2}} \sqrt{{γ}_{j}}}{\sqrt{v [ n ]} ( {σ}_{{𝒮}_{j}}^{2} + {σ}_{{𝔅}_{j}}^{2} )} - \frac{{σ}_{{𝒩}_{j}}^{2}}{{σ}_{{𝒮}_{j}}^{2} + {σ}_{{𝔅}_{j}}^{2}} , \qquad ∀ j$ |
| 17: | for j ← 1 to J do |
| 18: | if αⱼ[n] > 0 then |
| 19: | Mⱼ[n] ← 1 |
| 20: | else |
| 21: | Mⱼ[n] ← 0 |
| 22: | for j ← 1 to J do |
| 23: | if Mⱼ[n] = 0 then |
| 24: | αⱼ[n] ← 0 |
| | return {α₁, . . . , α_{J}} |

Here line 18 is “update mask”, and line 24 is “where aⱼ≤0 set it to lower limit”.

FIG. 5 shows a block diagram of a wireless two-way communication device, e.g. an intercom device with a plurality of microphones to capture speech and a loudspeaker (or headphone or other electroacoustic transducer) to generate speech received from the far end. A processor P processes the microphone inputs according to the speech intelligibility enhancement algorithm of the invention SIE_A and transmits at least one audio signal represented in a wireless RF signal via an RF transmitter RFT. The device can further receive an audio input from a far end two-way communication device and via a speech decoder SC generate at least one audio signal accordingly.

To sum up, the invention provides a computer implemented method for generation of a speech intelligibility enhancement algorithm for a wireless two-way communication system to enhance speech intelligibility in noise at both a near-end and a far-end taking into account joint near-end and far-end noise and audio inputs at the far-end from multiple microphones to capture speech and noise. First, determining (D_SI_OT) a speech intelligibility optimization target, taking into account noise at the near-end and noise at the far-end. Next, determining (D_MVDR) a Minimum Variance Distortionless Response (MVDR) beamformer with a plurality of inputs by optimizing a cost function according to the speech intelligibility optimization target to determine a global optimum. Next, determining (D_FB_G) a set of frequency band dependent gains by optimizing a cost function according to the speech intelligibility optimization target to determine a global optimum of a concave optimization formulation. Finally, generating (G_SIE_A) the speech enhancement processing algorithm as a linear processor with the determined MVDR beamformer followed by the determined set of frequency band dependent gains. In this way, a simple technical-mathematical formulation has been achieved, and the resulting speech intelligibility enhancement is similar to related but complex prior art solutions. The resulting algorithm is suited for wireless two-way communication devices, such as intercom devices to be used in noisy environments, e.g. for firefighters, rescue personnel etc.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1. A computer implemented method for providing a speech enhancement processing algorithm for enhancement of speech intelligibility in a wireless two-way communication system between a far-end and a near-end, with multiple microphones at least at the far-end and at least one audio output, the method comprises
1) determining a speech intelligibility optimization target, taking into account based on i) noise at the near-end and ii) noise at the far-end,
2) determining, according to a predetermined algorithm, a Minimum Variance Distortionless Response (MVDR) beamformer with a plurality of inputs by optimizing a first cost function according to the speech intelligibility optimization target to determine a global optimum,
3) determining (D_FB_G), according to a predetermined algorithm, a set of frequency band dependent gains by optimizing a second cost function according to the speech intelligibility optimization target to determine a global optimum of a concave optimization formulation, and
4) generating (G_SIE_A) the speech enhancement processing algorithm comprising the determined MVDR beamformer and the determined set of frequency band dependent gains.

2. The method according to claim 1, further comprising storing the speech enhancement processing algorithm in a memory of a processor system of a wireless two-way communication system.

3. The method according to claim 2, wherein steps 1)-4) are performed only once.

4. The method according to claim 1, wherein the speech enhancement processing algorithm is arranged to process a plurality of microphone inputs at the far-end.

5. The method according to claim 4, wherein the speech intelligibility enhancement algorithm is arranged to generate an audio output in response to the plurality of microphone inputs at the far-end and at least an input indicative of the noise at the near-end.

6. The method according to claim 1, wherein the speech intelligibility optimization is based on only: the noise at the far-end and the noise at the near-end.

7. The method according to claim 1, wherein the speech intelligibility optimization target involves an approximated speech intelligibility index measure, and/or an extended short-time objective intelligibility based target.

8. The method according to claim 1, wherein the speech intelligibility optimization target involves an equal power constraint.

9. The method according to claim 1, wherein the set of frequency band dependent gains comprises a set of critical band dependent gains.

10. The method according to claim 9, wherein each frequency dependent gain of the set of frequency band dependent gains within a critical band of the set of critical band dependent gains are equal.

11. The method according to claim 1, wherein at least one room acoustic parameter indicative of acoustics environments at the far-end is taken into account in the determining of at least one of: the MVDR beamformer, and the set of frequency band dependent gains.

12. The method according to claim 1, wherein the determining of the Minimum Variance Distortionless Response (MVDR) beamformer involves optimizing a cost function with a Lagrangian formulation.

13. The method according to claim 1, further comprising storing the speech enhancement processing algorithm in a memory of a processor system on a wireless two-way communication device comprising a plurality of audio inputs and at least one audio output.

14. A computer program code arranged to cause, when executed on a device with a processor, causes the processor to perform steps comprising:
1) determining a speech intelligibility optimization target based on i) noise at a near-end and ii) noise at a far-end,
2) determining, according to a predetermined algorithm, a Minimum Variance Distortionless Response (MVDR) beamformer with a plurality of inputs by optimizing a first cost function according to the speech intelligibility optimization target to determine a global optimum,
3) determining), according to a predetermined algorithm, a set of frequency band dependent gains by optimizing a second cost function according to the speech intelligibility optimization target to determine a global optimum of a concave optimization formulation, and
4) generating a speech enhancement processing algorithm comprising the determined MVDR beamformer and the determined set of frequency band dependent gains.

15. The computer program code according to claim 14, further comprising storing the speech enhancement processing algorithm in a memory of a processor system of a wireless two-way communication system.

16. The computer program code according to claim 14, wherein the speech enhancement processing algorithm is arranged to process a plurality of microphone inputs at the far-end.

17. The computer program code according to claim 16, wherein the speech enhancement processing algorithm is arranged to generate an audio output in response to the plurality of microphone inputs at the far-end and at least an input indicative of the noise at the near-end.

18. The computer program code according to claim 14, wherein the speech intelligibility optimization target comprises an equal power constraint.

19. A wireless audio device comprising a processor system programmed to process a plurality of audio inputs for providing a speech enhancement processing algorithm, the processor configured to:
1) determine a speech intelligibility optimization target based on i) noise at a near-end and ii) noise at a far-end,
2) determine, according to a predetermined algorithm, a Minimum Variance Distortionless Response (MVDR) beamformer with a plurality of inputs by optimizing a first cost function according to the speech intelligibility optimization target to determine a global optimum,
3) determine, according to a predetermined algorithm, a set of frequency band dependent gains by optimizing a second cost function according to the speech intelligibility optimization target to determine a global optimum of a concave optimization formulation, and
4) generate a speech enhancement processing algorithm comprising the determined MVDR beamformer and the determined set of frequency band dependent gains.

20. The wireless audio device according to claim 19, wherein:
the audio device is arranged to generate an audio output in accordance with the speech enhancement processing algorithm and to transmit said audio output represented in a wireless signal to a second wireless device, and
the wireless audio device is arranged to receive an input indicative of noise from the second wireless device, and wherein the wireless audio device is arranged to apply said input indicative of noise from the second wireless device as input to the speech enhancement processing algorithm.

21.-28. (canceled)
